(19) United States
(12) Patent Application Publication
(10) Pub. No.: US 2014/0203541 A1
(43) Pub. Date: Jul. 24, 2014

(54) VEHICLE SIDE ROOF RAIL AIR BAG

(71) Applicant: GM Global Technology Operations LLC, Detroit, MI (US)

(72) Inventors: Wei Wei, Novi, MI (US); Moin U. Asjad, Troy, MI (US)

(73) Assignee: GM Global Technology Operations LLC, Detroit, MI (US)

(21) Appl. No.: 14/060,112

(22) Filed: Oct. 22, 2013

Related U.S. Application Data
(60) Provisional application No. 61/755,724, filed on Jan. 23, 2013.

(51) Int. Cl. B60R 21/231; B60R 21/213

(52) U.S. Cl. CPC B60R 21/23138; B60R 21/213
USPC 280/730.2

(57) ABSTRACT

One variation may include a roof rail air bag having a bulge portion constructed and arranged to extend medially into the occupant cabin of a vehicle a distance greater than the remaining portion of the roof rail air bag. Another variation may include a roof rail air bag having a bulge portion constructed and arranged to extend into the occupant cabin of a vehicle the bulge portion extending a distance so as to overlap at least a portion of an area to be protected or blocked by an inflated driver's side frontal air bag or passenger side frontal air bag. In one variation, the bulge portion may be integrated into the roof rail air bag cushion design. In another variation, the bulge portion may be a separate bulge air bag which may be deployed adjacent the roof rail air bag.

### CROSS-REFERENCE TO RELATED APPLICATIONS

This application claims the benefit of U.S. Provisional Application No. 61/755,724 filed on Jan. 23, 2013.

### TECHNICAL FIELD

The field to which the disclosure generally relates to includes vehicle air bags.

### BACKGROUND

Air bags have been used in a variety of vehicles.

### SUMMARY OF ILLUSTRATIVE VARIATIONS

A product comprising: a roof rail air bag having a first side constructed and arranged for deployment adjacent a vehicle door and having an opposite second side constructed and arranged to be nearest an occupant cabin of a vehicle, the second side being constructed and arranged so that in an inflated condition the roof rail air bag has a bulge portion which, during deployment in a vehicle, extends medially into the occupant cabin of the vehicle a distance greater than the remaining portion of the roof rail air bag.

In one variation, the bulge portion may be integrated into the roof rail air bag cushion design.

In another variation, the bulge portion may be a separate bulge air bag adjacent the roof rail air bag.

Another variation may include a method comprising providing a roof rail air bag having a bulge portion constructed and arranged to extend medially into an occupant cabin of a vehicle a distance greater than the remaining portion of the roof rail air bag, folding one portion of the bulge portion over at least one other portion of the bulge portion and thereafter rolling the roof rail air bag up.

Other illustrative variations will become apparent from the detailed description provided hereinafter. It should be understood that the detailed description and specific examples, while disclosing optional variations, are intended for purposes of illustration only and are not intended to limit the scope of the invention.

### BRIEF DESCRIPTION OF THE DRAWINGS

Select examples of variations will become more fully understood from the detailed description and the accompanying drawings, wherein:

FIG. 1 illustrates a perspective view of a vehicle with portions removed including a roof rail air bag illustrated in an unfolded but uninflated condition according to a number of variations.

FIG. 2 is an illustration of a vehicle including the roof rail air bag of FIG. 1 in an inflated condition including a bulge portion extending medially into the occupant cabin of the vehicle a distance greater than the remaining portions of the roof rail air bag according to a number of variations.

FIG. 3 is an illustration of the roof rail air bag of FIG. 2 in an inflated condition and showing the bulge portion of the roof rail air bag directing the occupant away from the door and the A pillar of the vehicle according to a number of variations.

FIG. 4A is a schematic illustration, in plan view, illustrating three alternative variations of a roof rail air bag wherein the bulge portion of the roof rail air bag is located at different positions according to a number of variations.

FIG. 4B is a schematic illustration, in plan view, illustrating three alternative variations of a roof rail air bag wherein the bulge portion of the roof rail air bag is located at different positions according to a number of variations.

FIG. 5A is a schematic sectional view illustrating a bulge portion of a roof rail air bag being folded according to a number of variations.

FIG. 5B is a schematic illustration of the roof rail air bag of FIG. 5A in an inflated condition according to a number of variations.

FIG. 5C illustrates the roof rail air bag of FIG. 5A in a rolled condition and connected to an inflator for installation in the roof rail of a vehicle according to a number of variations.

FIG. 6A is a schematic sectional view illustrating a roof rail air bag having a bulge portion being folded according to a number of variations.

FIG. 6B is a schematic illustration of the roof rail air bag of FIG. 6A in an inflated condition according to a number of variations.

FIG. 6C is a schematic illustration of the roof rail air bag of FIG. 6A in a rolled condition and connected to an inflator for installation and a roof rail of a vehicle according to a number of variations.

FIG. 7A is an illustration of a roof rail air bag with a bulge air bag overlaying the frontal region of the roof rail air bag according to a number of variations.

FIG. 7B is an illustration of a sectional view of FIG. 7A according to a number of variations.

### DETAILED DESCRIPTION OF ILLUSTRATIVE VARIATIONS

The following description of the variations is merely illustrative in nature and is in no way intended to limit the invention, its application, or uses.

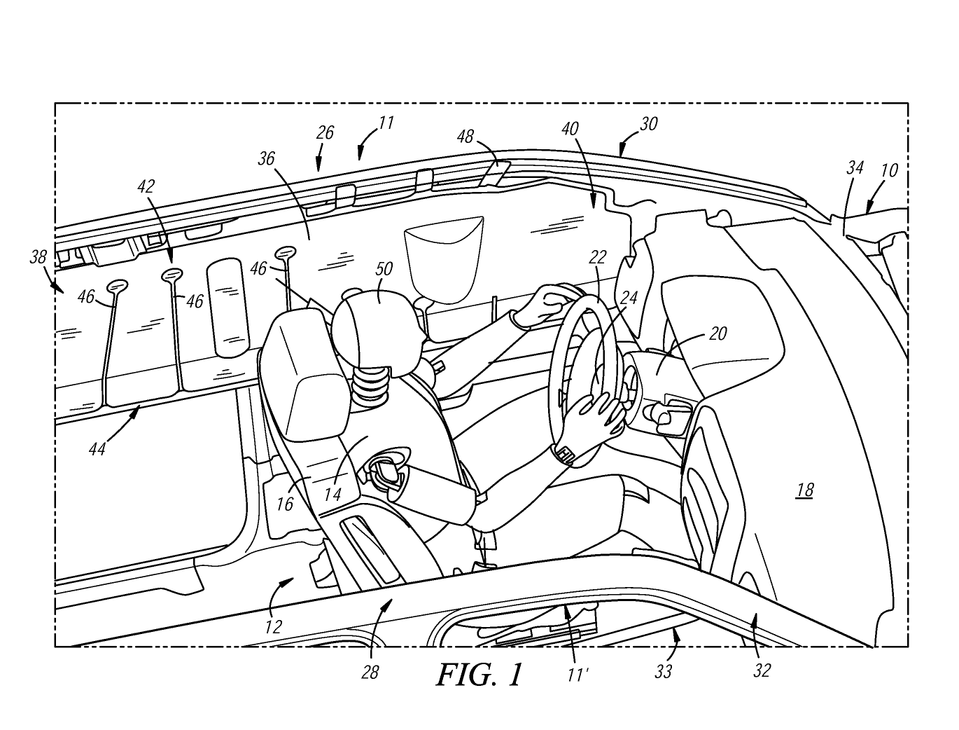

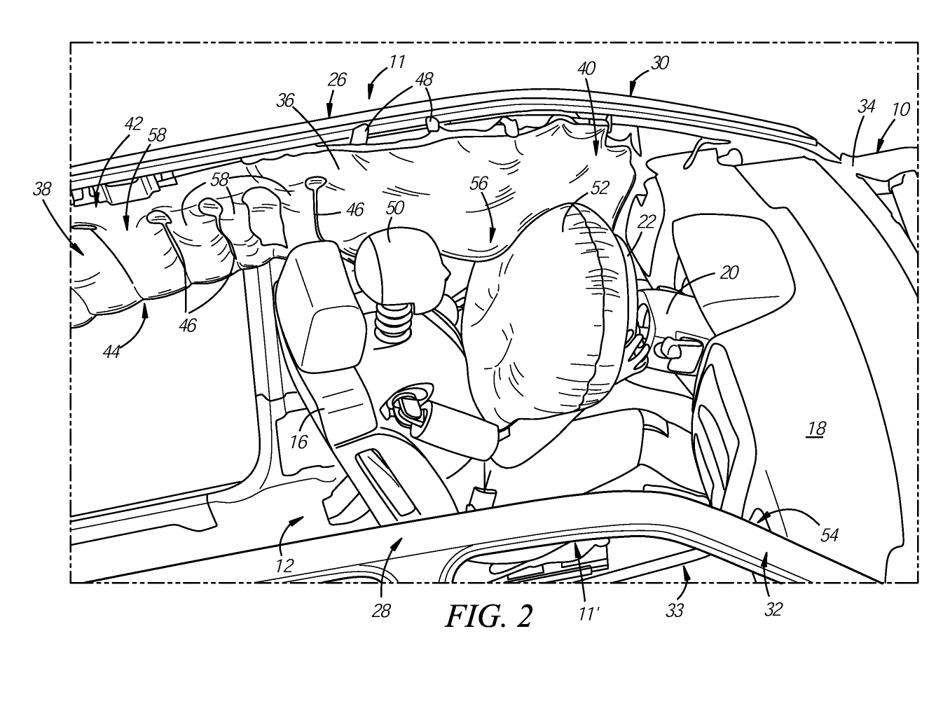

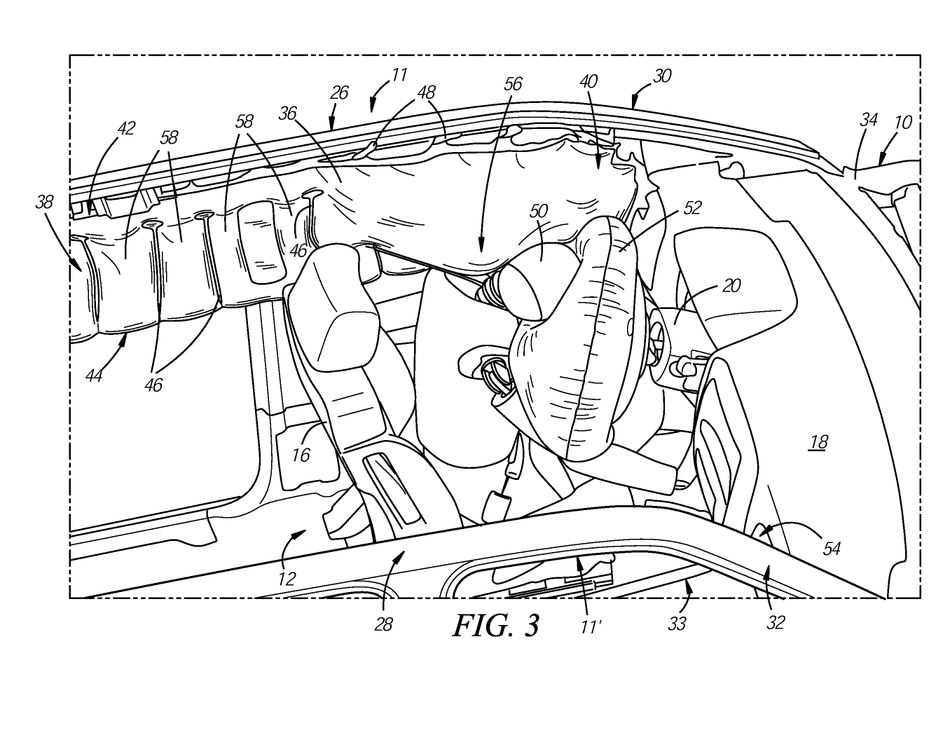

A number of variations are illustrated by FIG. 1 and may include a product including a vehicle 10 which may have an occupant cabin 12 in which one or more occupants 14 may ride in the vehicle in one or more seats 16. The vehicle 10 may include an instrument panel or dashboard 18. A steering column assembly 20 may extend from the instrument panel or dashboard 18 and have a steering wheel 22 connected thereto. A steering wheel hub 24 may be provided and may house a driver's side frontal air bag (not illustrated) which may be deployed during an impact event. The vehicle 10 may include a driver's side roof rail 26 and an opposite passenger side roof rail 28. A driver's side A pillar 30 may extend from the driver's side roof rail 26 to another structural component of the vehicle such as an engine compartment structure 34. Likewise, a passenger side A pillar 32 may extend from the passenger side roof rail 28 to another structural component of the vehicle such as the engine compartment structure 34. A door window 33 may be provided in the passenger side door 11′ and the driver's side door 11. A roof rail air bag 36 may be attached to the vehicle by, for example, tabs or straps 48 extending from the roof rail air bag 36 and attached to one of the roof rails 26, 28, for example with the use of a mechanical fastener (not illustrated). The roof rail air bag 36 may have a rear portion 38, an opposite front portion 40, a top portion 42, and an opposite bottom portion 44. A plurality of zero length tethers 46 may be formed in the roof rail air bag 36, for example, by stitching together one side of the roof rail air bag 36 to an opposite side or may be incorporated into a one-piece woven cushion. The zero length tether sections 46 help in the proper inflation of the roof rail air bag to produce a plurality of roof rail air bag inflated pouch sections 58 when the roof rail air bag is inflated, for example as illustrated in FIGS. 2-3.

A number of variations are illustrated by FIG. 2 which shows the roof rail air bag 36 of FIG. 1 in an inflated condition wherein the roof rail air bag 36 includes a bulge portion 56. In a number of variations the bulge portion 56 extends in a medial direction into the occupant cabin 12 a distance greater than the remaining portion of the roof rail air bag 36. In a number of variations the bulge portion 56 may be constructed and arranged to overlap a portion of the area designed to be protected or blocked by an inflated air bag 52 which may extend from the driver's steering wheel hub 24 or overlap a portion of a passenger's side frontal air bag in an inflated condition extending from the dashboard 18. The bulge portion 56 of the roof rail air bag 36 may prevent the occupant's head 50 from striking the A pillars 30, 32 or the window 33 on the driver's side or passenger's side respectively.

As illustrated in FIG. 3, in a number of variations, the bulge portion 56 may redirect an occupant's head during an impact event away from the A pillar 30, 32 and window 33 of the passenger's side door or driver's side door of the vehicle.

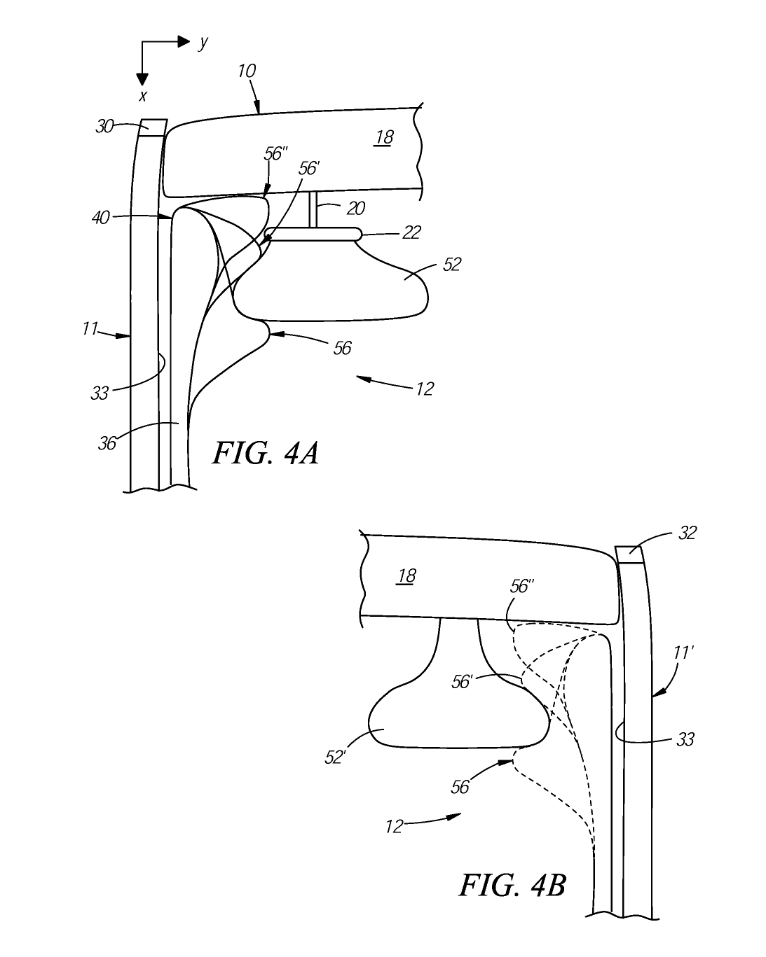

FIGS. 4A-B is a schematic illustration of three alternative variations of a roof rail air bag 36 having a bulge portion 56, 56′ and 56″positioned at different locations in the roof rail air bag 36. In one variation, a roof rail air bag 36 may be provided with a bulge portion 56 constructed and arranged to extend into the occupant compartment 12 of the vehicle 10. The bulge portion 56 may extend in front of a driver's side frontal air bag 52 connected to the wheel hub 24. A part of the bulge portion 56 may be positioned between the driver and the inflated driver's side frontal air bag 52 connected to the wheel hub 24.

In a second variation, a bulge portion 56′ may extend into the passenger compartment 12 and overlap a portion of the area protected by an inflated driver's side frontal air bag 52 or an inflated passenger side air bag 52′. In one variation a portion of the bulge portion 56′ extends behind an inflated driver's side air bag 52 or passenger side air bag 52′.

In an alternative variation, the bulge portion 56″ is positioned nearest the front of the roof rail air bag 36 and includes a portion overlapping the area protected by an inflated driver's side frontal air bag 52 or passenger side frontal air bag 52′. The bulge portion 56″ may be positioned adjacent the instrument panel or dashboard 18.

In each of the three variations illustrated by FIGS. 4A-B, the bulge portions 56, 56′ and 56″ in combination with a driver side frontal air bag 52 or passenger side frontal air bag 52′ may provide a protective curtain preventing the driver or a passenger from striking the A pillar 30, 32 or the window 33 of the driver's door 11 or passenger door 11′ respectively.

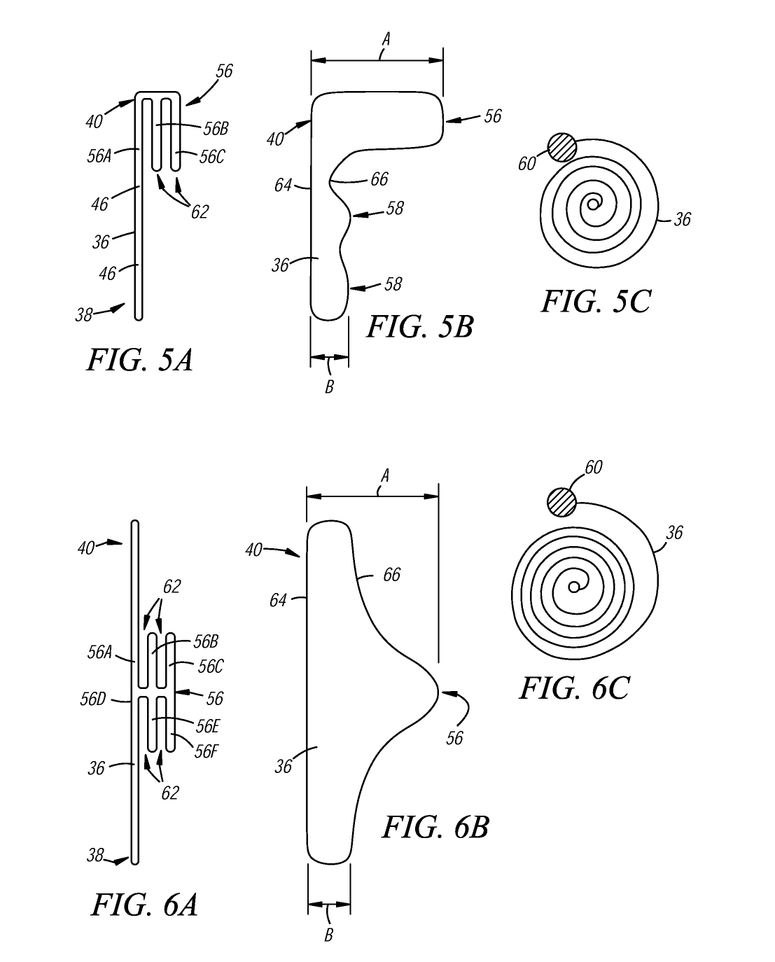

FIG. 5A illustrates a roof rail air bag 36 having a bulge portion 56 near a front portion 40 of the roof rail air bag 36. The bulge portion 56 may be folded so that a second portion 56B is folded over a first portion 56A and a third portion 56C may be folded over the second portion 56B of the bulge portion 56 with spaces 62 between each folded over portion. Several other portions of the bulge portion 56 may be folded over on another portion. The folding of the bulge portion 56 allows the roof rail air bag 36 to be rolled up and connected to an inflator 60 for installation in a roof rail 26, 28 of a vehicle 10 as illustrated in FIG. 5C. FIG. 5B is a sectional view of the roof rail air bag 36 of FIG. 5A in an inflated condition. As illustrated in FIG. 5B, the bulge portion 56 may extend medially a distance into the occupant cabin 12 of the vehicle a distance as shown by A which is greater than the distance shown by B of any other portion of the roof rail air bag 36.

FIG. 6A is a sectional plan view of a roof rail air bag 36 having a bulge portion 56 spaced a distance from a front portion 40 of the roof rail air bag 36. A plurality of portions 56A, 56B, 56C may be folded over each other with a space 62 therebetween a plurality of other portions 56D, 56E, and 56F may be folded over each other with a space 62 between adjacent folded over sections. The folded over portions of the bulge portion 56 allows the roof rail air bag 36 to be rolled up from the bottom towards the top portion and connected to an inflator 60 as shown in FIG. 6C for installation in a roof rail of a vehicle according to a number of variations. FIG. 6B illustrates the roof rail air bag of FIG. 6A in an inflated condition. For example, as illustrated in FIG. 6B, the bulge portion 56 may be spaced a distance from the front portion 40 of the roof rail air bag. The roof rail air bag 36 may have a first side 64 constructed to be adjacent the driver's side door 11 or passenger side door 11′ of the vehicle 10. The roof rail air bag 36 may have an opposite side 66 constructed and arranged to be positioned closest to the driver or passenger of the vehicle 10. For example, as illustrated in FIG. 6B, the bulge portion 56 may extend medially a distance A into the occupant cabin 12 which is greater than the distance illustrated by line B of any other portion of the roof rail air bag 36. In a number of variations, the distance A which the bulge portion 56 extends medially into the occupant cabin 12 may range from 12 inches to 24 inches. In comparison, the distance B that the remaining portion of the air bag extends medially into the occupant cabin 12 may range from 2 inches to 6 inches.

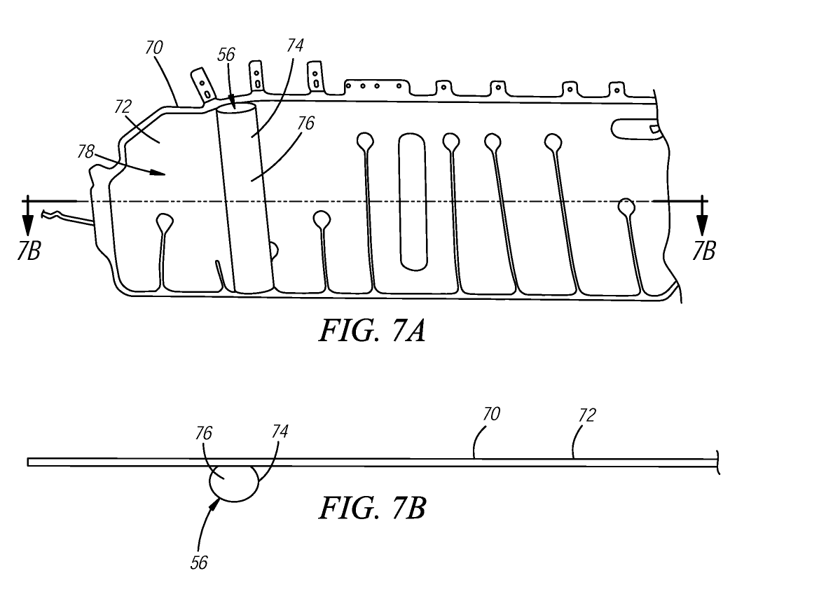

In another variation, referring to FIGS. 7A and 7B, the bulge portion 56 may be a separate component from the roof rail air bag 70. The separate component may comprise a bulge air bag 74. The size and shape of the bulge air bag 74 may vary depending on the performance requirements of the vehicle. In a number of variations the bulge air bag 74 may be a cylindrical air bag.

In one variation, the bulge air bag 74 and the roof rail air bag 70 may each be attached to the same inflator (not illustrated). The bulge air bag 74 may be placed adjacent the frontal portion 78 of the inboard side 66 of the roof rail air bag 70 closest to the vehicle occupants 14. When the inflator 60 activates, the inflator 60 may inflate both the bulge air bag 74 and the roof rail air bag 70 with gas causing the bulge air bag 74 and the roof rail air bag 70 to extend in a medial direction into the occupant cabin 12 (best illustrated in FIG. 1). In a number of variations, the bulge air bag 74 may extend in a medial direction into the occupant cabin 12 a distance greater than the roof rail air bag 70, for example, but not limited to, approximately twice the distance as the roof rail air bag 70. In a number of variations, the bulge air bag 74 may be constructed and arranged to overlap a portion of the area designed to be protected or blocked by an inflated frontal air bag 52 which may extend from the driver's steering wheel hub 24 or overlap a portion of a passenger side frontal air bag in an inflated condition extending from the dashboard 18. The bulge air bag 74 may prevent the occupant's head 50 from striking the A pillars 30, 32 or the window 33 (best illustrated in FIG. 1) on the driver's side or passenger's side respectively. The bulge air bag 74 may redirect an occupant's head during an impact event away from the A pillar 30, 32 and window 33 of the passenger's side door or driver's side door of the vehicle.

In another variation, the bulge air bag 74 and the roof rail air bag 70 may each be attached to independent inflators (not illustrated). The bulge air bag 74 may be attached to a first inflator and the roof rail air bag 70 may be attached to a second inflator. This may allow the bulge air bag 74 and the roof rail air bag 70 to have independent deployment times depending on vehicle requirements. The inflator output may also vary between the first and the second inflators so that the inflation level of the bulge air bag 74 may also be independent from the roof rail air bag 70 depending on vehicle requirements.

The following description of variants is only illustrative of components, elements, acts, products and methods considered to be within the scope of the invention and are not in any way intended to limit such scope by what is specifically disclosed or not expressly set forth. The components, elements, acts, products and methods as described herein may be combined and rearranged other than as expressly described herein and still are considered to be within the scope of the invention.

Variation 1 may include a product comprising: a roof rail air bag having a first side constructed and arranged for deployment adjacent a vehicle door and having an opposite second side constructed and arranged to be nearest an occupant cabin of a vehicle, the second side being constructed and arranged so that in an inflated condition the roof rail air bag has a bulge portion which, during deployment in a vehicle, extends medially into the occupant cabin of the vehicle a distance greater than the remaining portion of the roof rail air bag.

Variation 2 may include a product as set forth in Variation 1 further comprising a vehicle, and wherein the vehicle includes a passenger's side roof rail and a driver's side roof rail, and wherein the vehicle includes at least one of a driver's side frontal air bag or a passenger's side frontal air bag, the roof rail air bag being connected to one of the passenger's side roof rail or the driver's side roof rail, and wherein the bulge portion of the roof rail air bag overlaps a portion of the passenger's side frontal air bag or driver's side frontal air bag.

Variation 3 may include a product as set forth in any of Variations 1-2 further comprising a vehicle, and wherein the vehicle includes a passenger's side roof rail, wherein the vehicle includes a passenger's side frontal air bag, the roof rail air bag being connected to the passenger's side roof rail, wherein the bulge portion of the roof rail air bag extends in front of the passenger's side frontal air bag.

Variation 4 may include a product as set forth in any of Variations 1-3 further comprising a vehicle, and wherein the vehicle includes a driver's side roof rail, and wherein the vehicle includes a driver's side frontal air bag, the roof rail air bag being connect to the driver's side roof rail, wherein the bulge portion of the roof rail air bag extends in front of the driver's side frontal air bag.

Variation 5 may include a product as set forth in any of Variations 1-4 further comprising a vehicle, and wherein the vehicle includes a passenger's side roof rail, and wherein the vehicle includes a passenger's side frontal air bag, the roof rail air bag being connected to the passenger's side roof rail, wherein the bulge portion of the roof rail air bag extends behind the passenger's side frontal air bag.

Variation 6 may include a product as set forth in any of Variations 1-5 further comprising a vehicle, and wherein the vehicle includes a driver's side roof rail, and wherein the vehicle includes a driver's side frontal air bag, the roof rail air bag being connect to the driver's side roof rail, wherein the bulge portion of the roof rail air bag extends behind the driver's side frontal air bag.

Variation 7 may include a product as set forth in any of Variations 1-6 further comprising a vehicle, and wherein the vehicle includes a passenger's side roof rail, and wherein the vehicle includes a passenger's side frontal air bag, the roof rail air bag being connected to the passenger's side roof rail, wherein the bulge portion of the roof rail air bag extends behind the passenger's side frontal air bag and adjacent an instrumental panel or dashboard of the vehicle.

Variation 8 may include a product as set forth in any of Variations 1-7 further comprising a vehicle, and wherein the vehicle includes a driver's side roof rail, and wherein the vehicle includes a driver's side frontal air bag, the roof rail air bag being connected to the driver's side roof rail, wherein the bulge portion of the roof rail air bag extends behind the driver's side frontal air bag and adjacent an instrumental panel or dashboard of the vehicle.

Variation 9 may include a product comprising a roof rail air bag having a bulge portion constructed and arranged to extend medially into an occupant cabin of a vehicle a distance greater than a remaining portion of the roof rail air bag.

Variation 10 may include a product comprising a roof rail air bag having a bulge portion constructed and arranged to extend into an occupant cabin of a vehicle the bulge portion extending a distance so as to overlap at least a portion of an area to be protected or blocked by an inflated driver's side frontal air bag or passenger's side frontal air bag.

Variation 11 may include a method comprising providing a roof rail air bag having a bulge portion constructed and arranged to extend medially into the occupant cabin of a vehicle a distance greater than the remaining portion of the roof rail air bag, folding one portion of the bulge portion over at least one other portion of the bulge portion and thereafter rolling the roof rail air bag up.

Variation 12 may include a method as set forth in Variation 11 further comprising attaching an air bag inflator to the roof rail air bag.

Variation 13 may include a product comprising: a roof rail air bag having a first side and having an opposite second side, the second side being constructed and arranged so that in an inflated condition the roof rail air bag has a bulge portion extending from the first side a distance greater than the remaining portion of the roof rail air bag.

Variation 14 may include a product as set forth in any of Variations 1-13 wherein the bulge portion extends from the first side of the roof rail air bag at least twice the distance of the remaining portion of the roof rail air bag.

Variation 15 may include a product comprising: a bulge air bag constructed and arranged for deployment adjacent a portion of a roof rail air bag nearest an occupant cabin of a vehicle, the bulge air bag being constructed and arranged so that in an inflated condition the bulge air bag extends medially into the occupant cabin of the vehicle a distance greater than the roof rail air bag.

Variation 16 may include a product as set forth in Variation 15 further comprising a vehicle, wherein the vehicle includes a passenger's side roof rail and a driver's side roof rail; wherein the vehicle includes at least one of a passenger's side frontal air bag or a driver's side frontal air bag; wherein the vehicle includes at least one of a passenger's side roof rail air bag or a driver's side roof rail air bag; wherein the roof rail air bag and the bulge air bag are connected to at least one of the passenger's side roof rail or the driver's side roof rail; and wherein the roof rail air bag is attached to a first inflator and the bulge air bag is attached to a second inflator.

Variation 17 may include a product as set forth in any of Variations 15-16 wherein the bulge air bag overlaps a portion of the passenger's side frontal air bag or the driver's side frontal air bag.

Variation 18 may include a product as set forth in any of Variations 15-17 wherein the bulge air bag overlaps a portion of the passenger's side frontal air bag or the driver's side frontal air bag.

Variation 19 may include a product as set forth in any of Variations 15-18 wherein the bulge air bag extends in front of at least one of the driver's side frontal air bag or the passenger's side frontal air bag.

Variation 20 may include a product as set forth in any of Variations 15-19 wherein the bulge air bag extends behind at least one of the driver's side frontal air bag or the passenger's side frontal air bag.

Variation 21 may include a product as set forth in any of Variations 15-20 wherein the bulge air bag extends behind at least one of the driver's side frontal air bag or the passenger's side frontal air bag and adjacent an instrument panel or dashboard of the vehicle.

Variation 22 may include a product comprising a roof rail air bag and a bulge portion constructed and arranged to extend into an occupant cabin of a vehicle, the bulge portion extending a distance so as to overlap at least a portion of an area to be protected or blocked by an inflated driver's side frontal air bag or a passenger's side frontal air bag.

Variation 23 may include a product as set forth in any of Variations 15 or 22 further comprising a vehicle, wherein the vehicle includes a passenger's side roof rail and a driver's side roof rail; wherein the vehicle includes at least one of a passenger's side frontal air bag or a driver's side frontal air bag; wherein the vehicle includes at least one of a passenger's side roof rail air bag or a driver's side roof rail air bag; wherein the roof rail air bag and the bulge air bag are connected to at least one of the passenger's side roof rail or the driver's side roof rail; and wherein the roof rail air bag and the bulge air bag are each attached to an inflator.

Variation 24 may include a product as set forth in any of Variations 15, 22, or 23 wherein the bulge air bag overlaps a portion of the passenger's side frontal air bag or the driver's side frontal air bag.

Variation 25 may include a product as set forth in any of Variations 15, or 22-24 wherein the bulge air bag is constructed and arranged to extend medially into the occupant cabin of the vehicle a distance twice that of the roof rail air bag.

Variation 26 may include a product as set forth in Variation 16 wherein the first inflator has an output different than the second inflator.

The above description of select examples of the invention is merely exemplary in nature and, thus, variations or variants thereof are not to be regarded as a departure from the spirit and scope of the invention.

What is claimed is:

1. A product comprising:
a roof rail air bag having a first side constructed and arranged for deployment adjacent a vehicle door and having an opposite second side constructed and arranged to be nearest an occupant cabin of a vehicle, the second side being constructed and arranged so that in an inflated condition the roof rail air bag has a bulge portion which, during deployment in a vehicle, extends medially into the occupant cabin of the vehicle a distance greater than the remaining portion of the roof rail air bag.

2. A product as set forth in claim 1 further comprising a vehicle, and wherein the vehicle includes a passenger's side roof rail and a driver's side roof rail, and wherein the vehicle includes at least one of a driver's side frontal air bag or a passenger's side frontal air bag, the roof rail air bag being connected to one of the passenger's side roof rail or the driver's side roof rail, and wherein the bulge portion of the roof rail air bag overlaps a portion of the passenger's side frontal air bag or driver's side frontal air bag.

3. A product as set forth in claim 1 further comprising a vehicle, and wherein the vehicle includes a passenger's side roof rail, wherein the vehicle includes a passenger's side frontal air bag, the roof rail air bag being connected to the passenger's side roof rail, wherein the bulge portion of the roof rail air bag extends in front of the passenger's side frontal air bag.

4. A product as set forth in claim 1 further comprising a vehicle, and wherein the vehicle includes a driver's side roof rail, and wherein the vehicle includes a driver's side frontal air bag, the roof rail air bag being connected to the driver's side roof rail, wherein the bulge portion of the roof rail air bag extends in front of the driver's side frontal air bag.

5. A product as set forth in claim 1 further comprising a vehicle, and wherein the vehicle includes a passenger's side roof rail, and wherein the vehicle includes a passenger's side frontal air bag, the roof rail air bag being connected to the passenger's side roof rail, wherein the bulge portion of the roof rail air bag extends behind the passenger's side frontal air bag.

6. A product as set forth in claim 1 further comprising a vehicle, and wherein the vehicle includes a driver's side roof rail, and wherein the vehicle includes a driver's side frontal air bag, the roof rail air bag being connected to the driver's side roof rail, wherein the bulge portion of the roof rail air bag extends behind the driver's side frontal air bag.

7. A product as set forth in claim 1 further comprising a vehicle, and wherein the vehicle includes a passenger's side roof rail, and wherein the vehicle includes a passenger's side frontal air bag, the roof rail air bag being connected to the passenger's side roof rail, wherein the bulge portion of the roof rail air bag extends behind the passenger's side frontal air bag and adjacent an instrumental panel or dashboard of the vehicle.

8. A product as set forth in claim 1 further comprising a vehicle, and wherein the vehicle includes a driver's side roof rail, and wherein the vehicle includes a driver's side frontal air bag, the roof rail air bag being connected to the driver's side roof rail, wherein the bulge portion of the roof rail air bag extends behind the driver's side frontal air bag and adjacent an instrumental panel or dashboard of the vehicle.

9. A product comprising a roof rail air bag having a bulge portion constructed and arranged to extend medially into an occupant cabin of a vehicle a distance greater than a remaining portion of the roof rail air bag.

10. The product of claim 9 wherein the bulge portion extends from a first side of the roof rail air bag at least twice the distance of the remaining portion of the roof rail air bag.

11. A product comprising a roof rail air bag having a bulge portion constructed and arranged to extend into an occupant cabin of a vehicle the bulge portion extending a distance so as to overlap at least a portion of an area to be protected or blocked by an inflated driver's side frontal air bag or a passenger's side frontal air bag.

12. A method comprising providing a roof rail air bag having a bulge portion constructed and arranged to extend medially into an occupant cabin of a vehicle a distance greater than the remaining portion of the roof rail air bag, folding one portion of the bulge portion over at least one other portion of the bulge portion and thereafter rolling the roof rail air bag up.

13. A method as set forth in claim 12 further comprising attaching an air bag inflator to the roof rail air bag.

14. A product comprising:
a bulge air bag constructed and arranged for deployment adjacent a portion of a roof rail air bag nearest an occupant cabin of a vehicle, the bulge air bag being constructed and arranged so that in an inflated condition the bulge air bag extends medially into the occupant cabin of the vehicle a distance greater than the roof rail air bag.

15. A product as set forth in claim 14 further comprising a vehicle, wherein the vehicle includes a passenger's side roof rail and a driver's side roof rail;
wherein the vehicle includes at least one of a passenger's side frontal air bag or a driver's side frontal air bag;
wherein the vehicle includes at least one of a passenger's side roof rail air bag or a driver's side roof rail air bag;
wherein the roof rail air bag and the bulge air bag are connected to at least one of the passenger's side roof rail or the driver's side roof rail; and
wherein the roof rail air bag is attached to a first inflator and the bulge air bag is attached to a second inflator.

16. A product as set forth in claim 15 wherein the bulge air bag overlaps a portion of the passenger's side frontal air bag or the driver's side frontal air bag.

17. The product of claim 14 further comprising a vehicle, wherein the vehicle includes a passenger's side roof rail and a driver's side roof rail;
wherein the vehicle includes at least one of a passenger's side frontal air bag or a driver's side frontal air bag;
wherein the vehicle includes at least one of a passenger's side roof rail air bag or a driver's side roof rail air bag;
wherein the roof rail air bag and the bulge air bag are connected to at least one of the passenger's side roof rail or the driver's side roof rail; and
wherein the roof rail air bag and the bulge air bag are each attached to an inflator.

18. A product as set forth in claim 17 wherein the bulge air bag overlaps a portion of the passenger's side frontal air bag or the driver's side frontal air bag.

19. The product of claim 14 wherein the bulge air bag is constructed and arranged to extend medially into the occupant cabin of the vehicle a distance twice that of the roof rail air bag.

20. The product of claim 15 wherein the first inflator has an output different than the second inflator.
